(19) United States
(12) Patent Application Publication
(10) Pub. No.: US 2021/0272142 A1
(43) Pub. Date: Sep. 2, 2021

(54) METHOD FOR COMPILING MATERIAL ACCORDING TO VOCATION

(71) Applicant: COGNIZANCE LIMITED, Christchurch (NZ)

(72) Inventor: Matthew John Craig Walley, Christchurch (NZ)

(21) Appl. No.: 17/277,461

(22) PCT Filed: Sep. 20, 2019
(86) PCT No.: PCT/IB2019/057954

§ 371 Date: Mar. 18, 2021

(30) Foreign Application Priority Data
Sep. 21, 2018 (NZ) 746540

(51) Int. Cl. G06Q 30/02; H04L 12/58

(52) U.S. Cl. CPC G06Q 30/0204; H04L 51/046; G06Q 30/0203; G06Q 30/0201

(57) ABSTRACT

A method of allocating a psychographic profile to a vocational group, including the steps of: defining at least two psychographic profiles, each defined by a ranked score of at least two cognitive or personality traits; collecting data related to the at least two cognitive or personality traits for the vocational group; and analysing the data to determine which of the psychographic profiles best matches that vocational group. In another aspect, a method to compile a set of material elements for use in sales, advertising, or marketing applicable to a target group, including identifying a vocational group of each member of the target group; and allocating a psychographic profile to the vocational group.

### TECHNICAL FIELD

The present invention relates to a method of compiling a set of material elements, by selecting from a range of material elements relating to sales, advertising, and marketing communications those best suited to target members of a vocational group.

In various examples and embodiments, the material elements may be guidelines for creative development by a human or computer generator of content for use in sales, advertising, or marketing, or the material elements may be sales, advertising, or marketing content, including for example pre-generated sales contact material in the form of script elements for telemarketing, text and graphics for emails, including automated emails to mailing lists, text for short message system messages over cellular networks or internet messaging services, website advertisements, ecommerce interface elements.

### BACKGROUND

Any discussion of the prior art is not an admission that such art forms part of the common general knowledge in the field.

There is a desire to understand how and why consumers or purchasers make the decisions they make, to improve sales by more specifically targeting the recipient. For example, some people respond better to a personal approach, others to objective facts.

A number of systems have therefore been proposed for analysing past purchasing behaviour of individuals to predict future purchasing behaviour, and target advertising accordingly.

Psychometrics is the branch of psychology that deals with the design, administration, and interpretation of quantitative tests for the measurement of psychological variables such as intelligence, aptitude, and personality traits. This is often used in the field of recruitment for determining the suitability of individual applicants for certain roles.

Psychographics is the study and grouping of people according to their attitudes and tastes, and is a wider population based analysis not focussed on the characteristics of particular individuals within a population, but the “norms” for that population.

The term “personality trait” as used herein carries its standard meaning in the field of personality psychology, which is narrower than the everyday usage of the term.

Accordingly to a theory or model, sometimes known as “Big Five”, or “Five-Factor Model”, many personality traits can be grouped into five broad factors or dimensions, Extraversion (sometimes called Surgency), Agreeableness, Conscientiousness, Emotional Stability (sometimes reversed and called Neuroticism), and Openness to Experience (sometimes called Intellect or Intellect/Imagination).

Different researchers in the field of psychographics have constructed different models of personality traits informing each factor, and developed “scales” of assessment. For example, the International Personality Item Pool (“IMP”) is described as a scientific collaborator for the development of advanced measures of personality and other individual differences, and to includes over 3,000 “items” and over 250 scales constructed from the items, available for use on an open source basis.

Different researchers must exercise considerable skill and judgment in selecting which measures to include in any study, depending on the particular distinctions they wish to explore. Some measurement systems test hundreds of items, others for as few as 10, to produce a is psychological inventory.

It is an object of the present invention to provide an alternative method for selection of appropriate content and/or provide the public with a useful choice.

### DISCLOSURE OF INVENTION

Therefore the present invention provides a method of allocating a psychographic profile to a vocational group, including the steps of:
Defining at least two psychographic profiles, each defined by a ranked score of at least two cognitive or personality traits;
Collecting data related to the at least two cognitive or personality traits for the vocational group; and
Analysing the data to determine which of the psychographic profiles best matches that vocational group.

Preferably psychographic profile is defined by a ranked score of at least five cognitive or personality traits. In a preferred embodiment, the cognitive or personality traits used in defining each psychographic profile are agreeableness, conscientiousness, emotional stability, extraversion, and openness to experience.

Preferably each cognitive or personality trait includes multiple sub-traits.

Preferably at least six psychographic profiles are defined. More preferably at least 10 psychographic profiles are defined.

In a preferred embodiment, in the defining step, each cognitive or personality trait is ranked as low, moderate, or high. Preferably the analysing step includes comparing the data for each cognitive or personality trait against the rank for that trait in each personality profile to identify the closes match.

Preferably the at least two psychographic profiles are distinguished according to consumption focussed requirements and desires.

The present invention further provides a method of compiling a set of material elements for use in sales, advertising, or marketing applicable to a target group, including the steps of:
Identifying a vocational group of each member of the target group;
Allocating a psychographic profile to the vocational group using the method according to any one of claims 1 to 9;
Compiling a material elements database containing multiple elements;
Assigning each material element in the material element database either a positive, negative, or neutral association with each of at least two psychographic profiles;
Comparing the psychographic profile for the vocational group with the material elements database;
Compiling a selection of material elements with the strongest positive and negative associations into a set of material elements.

Preferably the method further includes the steps of:
assigning each material element in the material elements database a rating associated with at least one trait; and
comparing the traits for the vocational group with the material elements database.

In a preferred embodiment the method further includes the steps of:
assigning each material element in the material elements database a rating associated with at least one sub-trait; and
comparing the sub-traits for the vocational group with the material elements database.

In a preferred embodiment, the material elements are selected from: guidelines for creative development by a human or computer generator of content for use in sales, advertising, or marketing; and sales, advertising, or marketing content. More preferably, the material elements are content selected from: pre-generated sales contact material in the form of script elements for telemarketing, text and graphics for emails, including automated emails to mailing lists, text for short message system messages over cellular networks or internet messaging services, website advertisements, ecommerce interface elements.

The present invention further provides a method of compiling a set of guideline elements for use in sales, advertising, or marketing applicable to a target group, including the steps of:
Identifying a vocational group of each member of the target group;
Allocating a psychographic profile to the vocational group using the method described above;
Compiling a guidance elements database containing multiple guidance elements;
Assigning each guidance element in the guidance element database either a positive, negative, or neutral association with each of at least two psychographic profiles;
Comparing the psychographic profile for the vocational group with the guidance elements database;
Compiling a selection of guidance elements with the strongest positive and negative associations into a set of guideline elements.

Preferably the method includes the further steps of:
assigning each guidance element in the guidance element database a rating associated with at least one trait; and
comparing the traits for the vocational group with the guidance elements database.

In a preferred embodiment, the method includes the further steps of:
assigning each guidance element in the guidance element database a rating associated with at least one sub-trait; and
comparing the sub-traits for the vocational group with the guidance elements database.

The present invention further provides a method of targeting sales contact to a vocational group, including the steps of:
Allocating a psychographic profile to the vocational group using the method described above;
Compiling a sales contact elements database containing multiple sales contact elements;
Assigning each sales contact element in the sales contact element database either a positive, negative, or neutral association with each of the at least two psychographic profiles;
Comparing the psychographic profile for the vocational group with the sales contact elements database; and
Combining a selection of sales contact elements having the highest conformity with the psychographic profile for that vocational group.

Preferably the elements of sales contact relate to the requirements for purchase.

Preferably the step of determining elements of sales contact suitable for that psychographic profile includes the steps of:
Determining elements of sales contact suitable for meeting the requirements for decision making of that psychographic profile; and
Selecting from within those elements those suitable for meeting the desires for decision making of that psychographic profile.

The sales contact elements may be selected from: script elements for telemarketing, text and graphics for emails, including automated emails to mailing lists, text for short message system messages over cellular networks or internet messaging services, website advertisements, ecommerce interface elements.

In other aspects, the present invention includes one of the methods described above in at least one of:
a method of compiling sales material; or
a method of assembling a call centre script; or
a system for generating a display for ecommerce; or
a system for generating at least one email to one or more members of an email distribution list.

### BRIEF DESCRIPTION OF THE DRAWINGS

By way of non-limiting example only, preferred embodiments of the invention are described in detail below with reference to the accompanying drawings, in which:

FIG. 1 is a chart setting out the steps involved in defining a psychographic profile; and

FIG. 2 is a chart setting out the steps included in examples of implementing the method to of the present invention.

### BEST METHOD OF PERFORMING THE INVENTION

By way of non-limiting example, preferred embodiments of the present invention are described with reference to the accompanying drawings.

Multiple Cognitive Layers

It has been discovered that the way in which purchasing decisions are made involves multiple cognitive steps. It is interesting to note that different psychographic profiles may apply to the different layers of decision making, due to the different cognitive processes involved.

The primary profile is labelled the “required psychographic profile”. The requirements decision typology provides an overall indication of the base decision making factors considered. These act as a primary filter or gatekeeper for any purchasing decision. If these requirements are not met, the target will not consider making a purchase.

The secondary profile is labelled the “desired psychographic profile”. When someone is looking to make a decision they are initially captured by their desires; these are what they “want” in a purchase. For marketers understanding this is essential for capturing initial purchase interest.

The potential customer then progresses to the consideration phase, where the required psychographic profile applies. For a low involvement purchase, once desires have influenced immediate awareness, requirements solidify the decision.

For high involvement purchases, once the purchasing requirements have been met, the decision maker is then swayed by their purchasing desires. The desired typology acts to filter the dominant required typology. It may help determine the choice between viable alternatives.

Defining Psychographic Profiles

In order to target sales contact material to the recipient, the potential recipients are divided up into groups having different psychographic profiles.

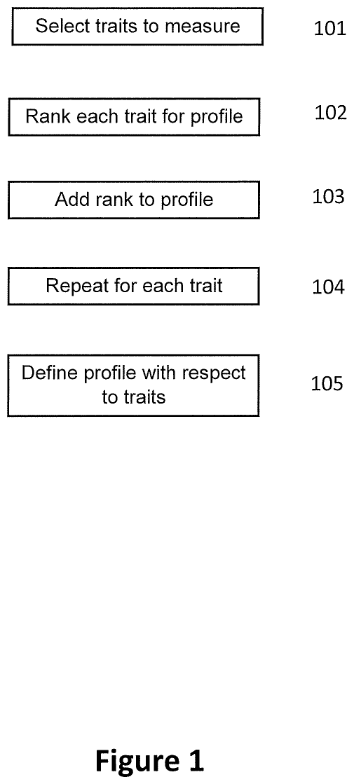

Each psychographic profile is defined using the process described with reference to FIG. 1. The first step 101 is to select the cognitive or personality traits that will be measured in defining the profile. These traits may be selected from the open source items provided by IPIP. In the to detailed examples given herein, the traits considered are Agreeableness, Conscientiousness, Emotional Stability, Extraversion, and Openness to Experience. It will be obvious to one skilled in the art that different sub-traits inform each of these traits.

The second step 102 in defining a psychographic profile is to rank each trait as low, moderate, or high. A first psychographic profile described as a detailed example is labelled is “Individualist”; a second psychographic profile described as a detailed example is labelled “Conformist”. Each traits may be ranked for each of these profiles, and at step 103 that rank is added to the profile. At step 104 the ranking and adding steps are repeated for each trait, until at step 105 the profile is defined with respect to the traits. In the two examples, the final defined psychographic profile may be:

| Trait | Individualist | Conformist |
|---|---|---|
| Agreeableness | Low | High |
| Conscientiousness | Low | High |
| Emotional Stability | Moderate | Moderate |
| Extraversion | High | Moderate |
| Openness to Experience | High | Low |

### First Example Psychographic Profile—Individualist

An Individualist views creativity and difference in their consumption choices as the primary mechanism for determining their self-identity. The predominant value driving their consumption is self-awareness, with decisions geared towards fulfilling personal desires. As such their decision framework is inner directed. Demographically the audience is skewed to 20-40 year olds, with no identified skew on resources, gender or educational background.

As a group Individualists cluster around the identity of a company or brand, and view this identity as reflected on and part of their own identity. They are early adopters on the diffusion curve, preferring to use products and services not accepted by the status quo. As companies and brands mature on the diffusion curve individualists will often see this as a challenge to their individualism and identity and move to other brand choices.

Individualists are a highly social group within their niches and are susceptible to advertising that is carefully configured to appeal to their desires. They are always open to new to consumption choices and will move quickly between brands if new options better suit their desired identity.

Agreeableness: The Individualist typology is a lower agreeableness customer group. They are somewhat emotional about their purchase decisions as they define their self-identity. They show strong empathy in their consumption choices with regards to how others in their social is group will view these choices. They are concerned with morality of their choices or their impacts on others, but not as a primary driver in the decision making process.

Conscientiousness: The Individualist typology demonstrates a low level of conscientiousness. They only make purchase decisions with a view to defining or reinforcing their self-identity. As such they are quick to make decisions with minimal consideration. Their decision framework is often disorganised and irrational from an economic perspective, but in doing so demonstrate a strong level of self-direction.

Emotional Stability: The Individualist typology exhibits a moderate level of emotional stability throughout the majority of the purchase process. They generally view the consumption process as a positive and exciting experience. They are open to advertising materials, particularly when endorsed or associated with those they identify as part of their group. Given the emotional energy dedicated to their consumption choices they are more susceptible to over emphasising negative experiences in the purchase process, leading to feelings of ‘being betrayed’ by a trusted brand.

Extraversion: The Individualist typology demonstrates a high level of extraversion. This group values interpersonal interaction throughout the purchase process seeing engagement with companies, brands and sales representatives as a mechanism for reinforcing their identity. An overall positive consumption experience is vital to strengthen customer relationships with this group.

Openness to Experience: The Individualist typology is very open to experiences. This is strongest trait that identifies this group. By valuing creativity as a mechanism of standing out from the status quo the individualist is always exploring for new experiences. Members of this group have highly active imaginations and can enjoy visualising/fantasising about how new choices will reinforce or enhance their personal identity.

### Second Example Psychographic Profile—Conformist

The conformist consumer typology is primarily concerned with adhering to mainstream values and believes. The predominant focus of their consumption is fulfilling their primary need through widely accepted and proven channels. As such their decision framework is outer directed. Demographically the audience is skewed to 35 plus year olds with a moderate level of resources, there is no gender skew in this grouping. Conformist consumers cluster very close to the traditionalist grouping, with subtle differences in regard to psychographic typology and basis for their decision making.

Conformist consumers are concerned with the social aspects of their consumption decisions, aiming to maintain societal norms and the status quo. They sit within the mid to late majority on the diffusion curve, preferring to make choices that offer utility, reliability and are generally accepted as the ‘proven choice’. They demonstrate strong brand loyalty and are slow to adopt emerging offerings.

Conformist consumers are welcoming of traditional advertising methods and are responsive to endorsements. The more widely accepted a consumption decision is socially, the more likely they are to commit to purchase.

Agreeableness: The conformist typology is a very high agreeableness customer group. They enjoy the warmth of being part of something that is widely accepted in the society. They value co-operation throughout the purchase process driven by a desire for harmony. They demonstrate a high level of calmness. Maintaining integrity is a core value of this group.

Conscientiousness: The conformist typology demonstrates a high level of conscientiousness. Purchase decisions are assessed with great care to ensure that adverse social consequences will not arise. As such they are very slow to make high involvement decisions out of fear of the unknown, unlike intellectual and analytical who delay decisions to allow deeper research. They lack self-direction, instead looking to wider society for ‘inspiration’.

Emotional Stability: The conformist typology exhibits a moderate level of emotional stability throughout the purchase process. They invest a degree of emotional energy into the purchase process through concerns of ‘fitting in’. Due to the emotional involvement in their purchase decisions they are liable to develop negative emotions due to poor experiences that challenge their self-consciousness.

Extraversion: The conformist typology demonstrates a moderate level of extraversion. This group values interpersonal interaction throughout the purchase process, as it can act as a mechanism to reinforce their conformity. They enjoy friendly interactions as an indication of their inclusion and acceptance. They prefer a slower more considered pace to making purchase decisions, and will shy away from high energy situations.

Openness to Experience: The conformist typology demonstrates a very low openness to new experiences. This set of traits sits at the core of their value set. Any idea or concept that challenges their accepted norms, values or choices is immediately rejected.

Data Collection

Each vocational group carries out different types of tasks. Different tasks align with different cognitive or personality traits. It is therefore possible to correlate between publically available data (or readily available data sets) regarding different vocations and the strength of each trait or sub-trait using scales, such as a selection of the open source IPIP scales.

Alternatively targeted testing may be carried out on members of a particular vocation using a selection of IPIP scales, in order to determine the strength of the selected cognitive or personality traits for a new vocational group or sub-group.

In each case, a careful selection of sub-trait scales provides an indication of the overall strength of a chosen trait. For example, measurements of Altruism, Calmness, Cooperation, Empathy, Hostility, and Trust may determine the degree of Agreeableness.

Profile Matching

The strength of each trait is compared against each of the psychographic profiles to determine the best fit.

In this way, a psychographic profile most closely statistically aligned with members of a particular vocation can be determined from data about the tasks carried out by members of that vocation, with direct testing of the vocational members being only an optional, not a required step.

It will be appreciated that the more psychographic profiles are available, the closer the match of each vocation will be. Although only two profiles are provided herein as detailed examples, it will be apparent that with combinations low, moderate, and high rankings of five different traits available, many different profiles could be created. When considering more sub-traits, the number continues to increase. However, many of these theoretical combinations are statistically unlikely combinations to occur in real people. A range of six to twenty different psychographic profiles appears to be useful for differentiating sales contact.

Creative Guidance—First Application for Content Generation

In a first application of the present invention, the method is used to collate sets of guideline elements to be provided to a creative developer of content (whether a human or machine) for use in sales, advertising, or marketing from a database of available statements.

In one option, the methods of the present invention are embodied in software. Alternatively, these steps could be carried out by an appropriately skilled human being. The various steps described in this example may take place in a different order, and sometimes there may be a significant time delay (e.g. days to years) between steps. Sometimes different people or machines may be used to perform different steps.

Data related to at least two cognitive or personality traits for a vocational group may be provided in a vocational database. Alternatively, a vocational database may be assembled by targeting questionnaires (such as those provided in the IPIP scales) to members of that vocational group.

At least two pre-defined psychographic profiles are defined by a ranked score of at least two cognitive or personality traits. The vocational database is analysed to determine which of the psychographic profiles best matches that vocational group. It will be understood by one skilled in the art that these steps may take place days, or even years, in advance, and the results stored in a database.

A database of potential guidance elements is produced. Each guidance element is then assigned either a positive, negative, or neutral association with each psychographic profile. By way of example, with reference to the psychographic profiles of Individualist and Conformist:

Individualist:

| Positive Guidance | Negative Guidance |
|---|---|
| Elements (Do) | Elements (Do Not) |
| Emphasise new product features and | Emphasise that the brand or |
| benefits, especially those that are | product is known and trusted. |
| disruptive to the status quo. | |
| When possible, include social | Emphasise that price is a |
| influencer endorsement. | selling point of your |
| | offering. |
| Emphasise the social desirability | Emphasise clear features |
| of your offering. Possibly | of the offering. |
| consider advertising links | |
| direct to social channels. | |
| When possible include imagery | Emphasise elements of trust |
| that involves the product in | in your brand/offering. |
| use. | |
| | Emphasise the social status |
| | and prestige associated with |
| | the offering. |
| | Feel bound to ensure there |
| | is consistency between your |
| | current and past advertising |
| | messages. |

Conformist:

| Positive Guidance | Negative Guidance |
|---|---|
| Elements (Do) | Elements (Do Not) |
| Emphasise that the brand or | Emphasise new product features |
| product is known and trusted. | and benefits, especially those |
| | that are disruptive to the |
| | status quo. |
| Emphasise that price is a | Include imagery that involves |
| selling point of your | the product in use. |
| offering but do not overtly | |
| compare with competitors' | |
| pricing. This consumer is | |
| likely focused on price due | |
| to economic restrictions or a | |
| focus on maximising cost/ | |
| benefit. Note that not all | |
| consumers see quality and | |
| price as opposites on a | |
| scale. | |
| Emphasise clear features of | Emphasise the social status |
| the offering. Where possible | and prestige associated with |
| be descriptive about the | the offering. |
| features, avoid presenting | |
| ‘marketing benefits’. | |
| When possible, include social | |
| influencer endorsement. | |
| Emphasise the social accept- | |
| ability of your offering to | |
| your target market (true for | |
| niche or mass market). | |
| Reassure the customer of their | |
| choices by emphasising elements | |
| of trust in your brand/offering. | |
| Emphasise the social desir- | |
| ability of your offering. | |
| Possibly consider advertising | |
| links direct to social channels. | |
| This consumer is likely to | |
| show a tendency to towards | |
| brand loyalty, preferring | |
| predictability and certainty | |
| in their choices. Your offering | |
| must present a safe choice. | |
| Ensure there is consistency | |
| between your current and past | |
| advertising messages. | |

The selection of guidance elements can be further refined by applying to each guidance element a weighting based on the strength of specific traits and sub-traits within each psychographic profile.

Some of guidance elements are targeted to match the requirements for decision making for different psychographic profiles. Others target the desires for decision making for each psychographic profile typology. An appropriate ranking may be applied.

The steps of preparing a database of guidance options, assigning appropriate associations, weightings, and ranking may be carried out days, or even years, in advance.

According to this aspect of the present invention, the method includes the steps of:
Identifying a target vocational group;
Either:
   Carrying out the steps of:
      Defining at least two psychographic profiles, each defined by a ranked score of at least two cognitive or personality traits;
      Accessing the vocational database data related to the at least two cognitive or personality traits for the vocational group; and
      Analysing the data to determine which of the psychographic profiles best matches that vocational group; or
   If these steps have been carried out in advance, accessing a database to determine the best matched psychographic profile for that vocational group;
Comparing the psychographic profile with the guidance elements database
Optionally including comparison of the traits and/or sub-traits for that vocational group with the guidance elements database
Compiling a selection of guidance elements with the strongest positive and negative associations into a set of guideline elements.

Sales Contact—Second Application for Call Centre Script

In a second application of the present invention, the material elements consist of sales contact material in the form of a range of script options for a call centre. Different script options are targeted to appeal to the purchasing requirements (and optionally desires) of those falling into different psychographic profiles.

Before making a call, the caller determines the vocation of the intended target person. This may be from publically available information, such as company websites, or other readily available data sets. The most appropriate required psychographic profile for a member of that group is allocated, and the different script options assembled based on their suitability for that required psychographic profile. The caller can then proceed based on that script.

It will be recognised that the same method could also be applied to allocate the most appropriate desired psychographic profile for that group, and the script options, filtered by the required psychographic profile, further optimised according to their suitability for the desired psychographic profile.

In one option, the methods of the present invention are embodied in software. Alternatively, these steps could be carried out by an appropriately skilled human being. The various steps described in this example may take place in a different order, and sometimes there may be a significant time delay (e.g. days to years) between steps. Sometimes different people or machines may be used to perform different steps.

In a preferred embodiment, the steps of this process are automated by the use of a computer program.

Script Generation Software

In one option, the methods of the present invention are embodied in software for use by call centre staff. The various steps described in this example may take place in a different order, and sometimes there may be a significant time delay (e.g. days to years) between steps.

Data related to at least two cognitive or personality traits for a vocational group may be provided in a vocational database. Alternatively, a vocational database may be assembled by targeting questionnaires (such as those provided in the IPIP scales) to members of that vocational group.

The software may be pre-loaded with at least two pre-defined psychographic profiles, each defined by a ranked score of at least two cognitive or personality traits.

The vocational database is analysed to determine which of the psychographic profiles best matches that vocational group.

It will be understood by one skilled in the art that these steps may take place days, or even to years, in advance, and the results stored in a database to be accessed by the software.

A variety of script options are generated for each stage of the call. Some of these script options are targeted to match the requirements for decision making for different psychographic profiles. Others are designed to target the desires for decision making for each psychographic profile typology.

These script options are loaded into an options database, together with a score indicating their appropriateness for use when targeting each psychographic profile. This may include ranking according to suitability to meet both the requirements and desires for decision making. Again, these steps may be carried out days, or even years, in advance.

The software in use is designed to:
Accept input from a user as to the vocational group of the intended target;
Either:
   Carry out the steps of:
      Defining at least two psychographic profiles, each defined by a ranked score of at least two cognitive or personality traits;
      Accessing the vocational database data related to the at least two cognitive or personality traits for the vocational group; and
      Analysing the data to determine which of the psychographic profiles best matches that vocational group; or
   If these steps have been carried out in advance, accessing a database to determine the best matched psychographic profile for that vocational group;
Access the script options database;
Selecting for each stage of the call the script option best matched to that psychographic profile; and
Generating a script including those options.

Sales Contact—Third Application for Ecommerce Integration

In a third application, the method of the present invention is used to select elements for display on an ecommerce website. The various steps described in this example may take place in a different order, and sometimes there may be a significant time delay (e.g. days to years) between steps.

Data related to at least two cognitive or personality traits for a vocational group may be provided in a vocational database. Alternatively, a vocational database may be assembled by targeting questionnaires (such as those provided in the IPIP scales) to members of that vocational group.

The software may be pre-loaded with at least two pre-defined psychographic profiles, each defined by a ranked score of at least two cognitive or personality traits.

The vocational database is analysed to determine which of the psychographic profiles best matches that vocational group.

It will be understood by one skilled in the art that these steps may take place days, or even years, in advance, and the results stored in a database to be accessed by the software.

Material elements are prepared and loaded into a content database. For example, at the “cart” or “check out” stage, different display options are targeted to appeal to the purchasing requirements (and optionally desires) of those falling into different psychographic profiles. These may include options for discounts, additional products, alternative products, or loyalty programmes, which will appeal to those with different psychographic profiles.

These material elements are loaded into an options database, together with a score indicating their appropriateness for use when targeting each psychographic profile. This may include ranking according to suitability to meet both the requirements and desires for decision making. Again, these steps may be carried out days, or even years, in advance.

A user of the ecommerce site is asked to provide their vocation on signing up to use the site.

The system in use is designed to:
Either:
   Carry out the steps of:
      Defining at least two psychographic profiles, each defined by a ranked score of at least two cognitive or personality traits;
      Accessing the vocational database data related to the at least two cognitive or personality traits for the vocational group; and
      Analysing the data to determine which of the psychographic profiles best matches that vocational group; or
   If these steps have been carried out in advance, accessing a database to determine the best matched psychographic profile for that vocational group;
Access the options database;
Selecting the material elements best matched to that psychographic profile; and
Generating a display including those elements.

When introducing such a system, a series of initial psychographic segments may be determined from existing information such as purchasing data, the types of purchases, items in cart, discounting behaviour, purchase times, etc), according to known methods of doing so. Existing users can be prompted to supply their vocation. As more information is collected over time, any correlations can be mapped between the psychographic segments based on purchasing data, and the psychographic profiles developed according to vocation as detailed in accordance with the present invention. Feedback between the two models as additional data becomes available is expected to lead to increased accuracy in both.

Sales Contact—Fourth Application for Email Generation

In a fourth application, the method of the present invention is used to select elements for inclusion in an automated email to a distribution list. The various steps described in this example may take place in a different order, and sometimes there may be a significant time delay (e.g. days to years) between steps.

Data related to at least two cognitive or personality traits for a vocational group may be provided in a vocational database. Alternatively, a vocational database may be assembled by targeting questionnaires (such as those provided in the IPIP scales) to members of that vocational group.

The software may be pre-loaded with at least two pre-defined psychographic profiles, each defined by a ranked score of at least two cognitive or personality traits.

The vocational database is analysed to determine which of the psychographic profiles best matches that vocational group.

It will be understood by one skilled in the art that these steps may take place days, or even years, in advance, and the results stored in a database to be accessed by the software.

Material elements are prepared, consisting of options for sales contact material, such as information about discounts, new products, features and specifications, text, images, infographics.

These options are loaded into an options database, together with a score indicating their appropriateness for use when targeting each psychographic profile. This may include ranking according to suitability to meet both the requirements and desires for decision making. Again, these steps may be carried out days, or even years, in advance.

The mailing distribution list includes data as to the vocation of each member of the list. This may be solicited when members sign up to the list, compiled from business cards, or from publically available information such as websites, or other readily available data sets.

The system in use is designed to:
Generate a sub-set of an email distribution list according to vocation;
Either:
   Carry out the steps of:
      Defining at least two psychographic profiles, each defined by a ranked score of at least two cognitive or personality traits;
      Accessing the vocational database data related to the at least two cognitive or personality traits for the vocational group; and
      Analysing the data to determine which of the psychographic profiles best matches that vocational group; or
   If these steps have been carried out in advance, accessing a database to determine the best matched psychographic profile for that vocational group;
Access the options database;
Selecting the material elements best matched to that psychographic profile;
Generating and sending an email to that sub-set including the selected sales contact material; (or if no appropriate highly matched elements are available, sending no email to that sub-set); and

Repeating these Steps for Zero or More Additional Sub-Sets.

Sales contact—combined application

In a combined application, sales contact material is email content related to an ecommerce website. This may include cart abandonment notifications, reminders, price drops, alternative product offerings, or specials. The present invention further provides an interface for scoring is these elements according to their appropriateness for use when targeting both the requirements and desires for decision making for each psychographic profile, and loading them into an options database.

In preparing emails for sending to users of the website, the methods described above may be implemented with the necessary modifications. This may optionally include matching to the psychographic segment determined by known analytical methods.

Sales Contact Material Database Optimisation

The invention may provide a method for scoring elements according to their appropriateness for use when targeting both the requirements and desires for decision making for each psychographic profile. The accuracy can be improved by providing feedback from click-through rates of content provided to members of a particular vocational group when presented with different elements.

### Generalised Example

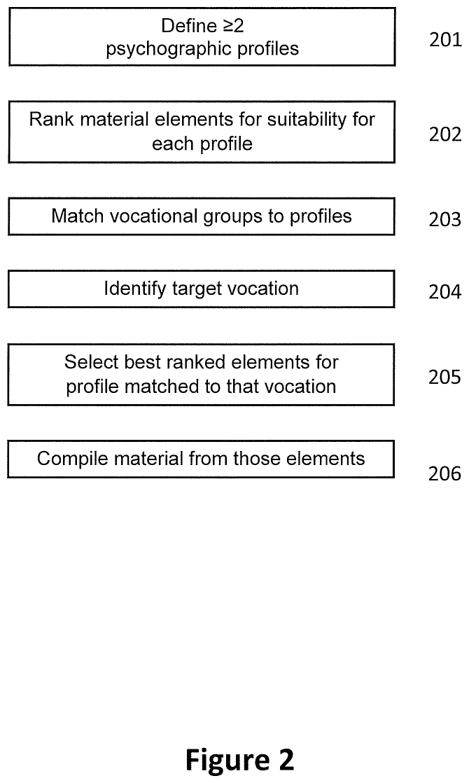

As will be clear to one skilled in the art, the examples given above share common features, such as those illustrated in FIG. 2, which illustrates one possible non-limiting order progression of steps:
Defining at least two psychographic profiles, each defined by a ranked score of at least two cognitive or personality traits (201);
Ranking material elements for suitability for each profile (202), which may include storing these in an options database;
Matching vocational groups to the profiles (203), which may include accessing vocational database data related to the at least two cognitive or personality traits for the vocational group; and analysing the data to determine which of the psychographic profiles best matches that vocational group;
Identifying the vocation of the intended target of the sales contact (204), which may be by asking them to provide this information, or by access to publically available information, or other readily available data sets;
Selecting the material elements best matched to the psychographic profile matched to that vocation (205), which may involve multiple steps based on a required psychographic profile and a desired psychographic profile, and/or consideration of traits and/or sub-traits within a psychographic profile;
Compiling material from the elements (206), which may be in the form of guidance for content generators, a phone script, display options on an ecommerce site, or generation of an email.

The embodiments shown and described in detail herein are by way of example only. The present invention is intended to include such modifications and variations thereto as may be obvious to one skilled in the art.

1-25. (canceled)

26. A method of compiling a set of material elements for use in sales, advertising, or marketing applicable to members of a target group having a common vocational group identifier, the method comprising steps of:
compiling a material elements database containing multiple elements;
defining at least two psychographic profiles, each psychographic profile defined by a ranked score of at least two cognitive or personality traits;
assigning to each element in the material elements database either a positive, negative, or neutral association with each of the at least two psychographic profiles;
collecting data listing tasks carried out by individuals associated with the common vocational group identifier;
associating each task with a correlation score for each of the at least two cognitive or personality traits;
comparing the correlation scores for each of the at least two cognitive or personality traits with its ranked score in each of the at least two psychographic profile to determine which psychographic profiles best matches the vocational group;
allocating the determined best matching psychographic profile to the common vocational group identifier; and
compiling from the material elements database a selection of material elements with the strongest positive associations with the best matching psychographic profile into a set of material elements.

27. The method of claim 26, further including the step of collecting supplementary correlation scores by direct testing of individual associated with the common vocational group identifier.

28. The method of claim 26, wherein each psychographic profile is defined by a ranked score of at least five cognitive or personality traits.

29. The method of claim 26, wherein each cognitive or personality trait includes multiple sub-traits.

30. The method of claim 29, further including steps of:
assigning to each personality profile designation a ranked score for each sub-trait;
assigning each material element in the material elements database a rating associated with at least one sub-trait; and
filtering the set of material elements to remove those having a low rating associated with sub-traits with a high ranked score assigned to that personality profile designation.

31. The method of claim 26, wherein the at least two psychographic profiles are distinguished according to consumption focused requirements and desires.

32. The method of claim 26, wherein the material elements comprise content selected from one or more of pre-generated sales contact material in a form of script elements for telemarketing; text and graphics for emails; text for short message system messages over cellular networks or internet messaging services; website advertisements; and ecommerce interface elements.

33. A method of compiling a set of guideline elements for use in sales, advertising, or marketing applicable to a target group, the method comprising steps of:
compiling a guidance elements database containing multiple guidance elements;
defining at least two psychographic profiles, each defined by a ranked score of at least two cognitive or personality traits;
assigning to each guidance element in the guidance elements database either a positive, negative, or neutral association with each psychographic profile;
identifying a vocational group identifier for each individual in the target group;
collecting data listing tasks carried out by individuals associated with each vocational group identifier;
associating each task with a correlation score for each of the traits;
comparing the correlation scores for each of the traits for each task in each vocational group identifier with its ranked score in each psychographic profile to determine which of the at least two psychographic profiles best matches that vocational group;
allocating the determined best matching psychographic profile to each vocational group identifier;
identifying the most common psychographic profile designation for the target group; and
compiling from the guidance elements database a selection of guidance elements with the strongest positive associations with the most common psychographic profile designation into a set of guidance elements.

34. The method of claim 33, further including the step of collecting supplementary correlation scores by direct testing of individual associated with the vocational group identifier.

35. The method of claim 33, wherein each psychographic profile is defined by a ranked score of at least five cognitive or personality traits.

36. The method of claim 35, further including the steps of:
assigning to each personality profile designation a ranked score for each trait;
assigning each material element in the guidance elements database a rating associated with at least one trait; and
filtering the set of guidance elements to remove those having a low rating associated with traits with a high ranked score assigned to that personality profile designation.

37. The method of claim 33, wherein each cognitive or personality trait includes multiple sub-traits.

38. The method of claim 37, further including steps of:
assigning to each personality profile designation a ranked score for each sub-trait;
assigning each material element in the guidance elements database a rating associated with at least one sub-trait; and
filtering the set of guidance elements to remove those having a low rating associated with sub-traits with a high ranked score assigned to that personality profile designation.

39. The method of claim 33, wherein the at least two psychographic profiles are distinguished according to consumption focused requirements and desires.

40. A method of targeting sales contact to a target group having a common vocational group identifier, including the steps of:
compiling a sales contact elements database containing multiple sales contact elements;
defining at least two psychographic profiles, each defined by a ranked score of at least two cognitive or personality traits;
assigning to each sales contact element in the sales contact elements database either a positive, negative, or neutral association with each of the at least two psychographic profiles;
collecting data listing tasks carried out by individuals associated with the common vocational group identifier;
associating each task with a correlation score for each of the at least two cognitive or personality traits;
comparing the correlation scores for each of the at least two cognitive or personality traits with its ranked score in each psychographic profile to determine which of the at least two psychographic profiles best matches the vocational group; and
selecting a set of sales contact elements having a highest conformity with the determined best matching psychographic profile.

41. The method of claim 40, wherein the sales contact elements relate to requirements for purchase.

42. The method of claim 40, the step of combining a selection of sales contact elements includes the steps of:
determining which sales contact elements have a positive association with requirements for decision making of the psychographic profile; and
selecting from within those sales contact elements those suitable for meeting desires for the decision making of that psychographic profile.

43. The method of claim 40, wherein the sales contact elements comprise text and graphics for emails, and wherein the selected set of sales contact elements are utilized to generate an automated email to a distribution list.

44. The method of claim 40, wherein the sales contact elements comprise ecommerce interface elements, and wherein the selected set of sales contact elements are utilized to generate a display on an ecommerce site.

45. The method of claim 40, wherein the sales contact elements comprise script elements for telemarketing, and wherein the selected set of sales contact elements are utilized to generate a call centre script.
